(19) United States
(12) Patent Application Publication
(10) Pub. No.: US 2007/0208815 A1
(43) Pub. Date: Sep. 6, 2007

(54) Methods and apparatus for implementing version-based electronic mail

(75) Inventors: Frank Lawrence Jania, Chapel Hill, NC (US); James Karl Kebinger, Somerville, MA (US); Darren Mark Shaw, Hampshire (GB); Brian D. Goodman, Norwalk, CT (US)

Correspondence Address: HARRINGTON & SMITH, PC, 4 RESEARCH DRIVE, SHELTON, CT, 06484-6212, US

(73) Assignee: International Business Machines Corporation

(21) Appl. No.: 11/367,294

(22) Filed: Mar. 2, 2006

(51) Int. Cl. G06F 15/16

(52) U.S. Cl. 709/206

(57) ABSTRACT

The present invention concerns methods and apparatus for managing e-mail creation and display operations. In particular, in one aspect of the invention, a new e-mail is generated as a new version of a pre-existing e-mail. Both the pre-existing and new e-mail are identified by version numbers which are displayed to both the e-mail author and to recipients of the e-mails. When displayed, both the new and pre-existing e-mail are initially collectively identified by a single entry in a graphical user interface, where the entry preferably provides information concerning the new e-mail, including at least the version number, and implies the existence of the pre-existing e-mail through display of a version number. The new e-mail is immediately accessible by selecting the entry, and previous versions of the e-mail are accessible by toggling a graphical control. Upon toggling the graphical control, entries for each prior version of an e-mail become visible, allowing a user to immediately access individual ones by selecting their respective entry. Similar version methods are used in managing the creation and display of e-mails generated by multiple users.

### TECHNICAL FIELD

The present invention generally concerns e-mail application programs, and more particularly concerns both e-mail application programs where e-mails are generated as new versions of pre-existing e-mails, and e-mail application programs where e-mails generated by multiple users concerning a topic are each assigned a version number and are accessible either as a group or individually from a single graphical user interface.

### BACKGROUND

E-mail, as supported by current e-mail application programs, has become a common and widely-used mode of communication. The ability to send a written message immediately is very useful. For example, alternatives like telephone conversations and telephone messaging may be far less reliable. Using telephone conversations to convey complex information is fraught with problems. The person conveying the information may or may not operate from notes. If the person conveying the information is not operating from notes, the person may forget a topic or item of information necessitating a follow-up telephone conversation. Alternatively, the person receiving the information may not take notes, and may later forget all that was discussed during the telephone conversation. This assumes that the parties to the telephone conversation are available at the same time to transact the telephone conversation. In the busy business world this is frequently not the case, meaning that a person may have to wait to until the other person becomes available. Time is frequently wasted waiting for the time to arrive to have the telephone conversation.

Persons often leave telephone messages when the other party to a desired telephone conversation cannot be reached. Telephone messaging is also fraught with problems. Frequently, telephone messaging services impose time limits on messages, and telephone message storage resources are usually finite in length. Spreading complex information over many message segments makes it difficult for the recipient to recover the information. Further, the fact that the telephone message is spoken also presents problems. A person may pause while speaking a message to a telephone messaging service, introducing a blank space in a message which may give the recipient the incorrect impression that the message has ended.

E-mail overcomes many of these limitations. It is usually easier to convey a complex message, or even a short, but multi-part, message, using a written form of communication. E-mail provides this ability. E-mail is also not dependent on the current availability of a user and can be sent immediately. E-mail also has features not available in telephone messaging, like a facility for indicating when a recipient of an e-mail opens the e-mail message.

Nonetheless, e-mail, as practiced in current e-mail application programs, has limitations. The ability to issue an immediate communication often leads users to spend an insufficient time composing an e-mail message. It is not an unusual experience for a sender of an e-mail to realize, sometimes just moments after sending an e-mail, that the sender has left something out; made grammatical or spelling errors; made factual errors; given the wrong impression; or even inadvertently introduced an element that might be distractingly humorous (being unintentionally funny in certain circumstances is not necessarily a good thing).

E-mail application programs have limited ability to deal with these situations. For example, a user may just send another e-mail. If e-mail is being used to manage an evolving situation, where instructions are being refined as new facts develop, sending a new e-mail each time refined instructions need to be sent spreads the messaging activity over many separate e-mails that are not related in any particular way. A recipient of the e-mails may lose track of where a particular issue is discussed in a chain of e-mails.

Alternatively, a sender of e-mails may send a refined e-mail by using the forwarding command. The problem with this is that e-mail application programs typically append the preceding e-mail message to the end of the new message since the original intent of the forwarding facility is to forward a message received from a third party to another. This means that the message already sent by the sender is appended to the end of the new e-mail message. If the earlier message contains a gaffe, the gaffe is repeated every time the message is refined using the forwarding command.

E-mail is also being used as a tool for developing content (art, text, presentations, etc.) collaboratively. Since this was not the original intent of e-mail this is typically accomplished by forwarding e-mails back and forth. This has the negative consequences of cluttering the correspondents' respective inboxes and transferring redundant data repeatedly.

The conventional art in this space typically displays content-related e-mail messages in thread views. This is typically ineffective and does not take into consideration the notion of shared changes to the actual content of the message, but as further appends to a copy of the original document.

Applicable to both of these problematic areas is the fact that e-mail systems are also being used as ad-hoc document management systems. E-mail was also never intended to serve this purpose.

Accordingly, those skilled in the art desire improved e-mail application programs that overcome the foregoing and other limitations of the prior art.

### SUMMARY OF THE PREFERRED EMBODIMENTS

The foregoing problems and other problems are overcome, and other advantages are realized, in accordance with the following embodiments of the present invention.

A first embodiment of the invention comprises a signal-bearing medium tangibly embodying a program of machine-readable instructions executable by a digital processing apparatus of a computer system to perform operations for managing an e-mail application, the operations comprising: receiving a plurality of e-mails, wherein each e-mail of the plurality corresponds to a particular version, wherein the versions range from least recent to most recent; in a graphical user interface generated by the e-mail application, displaying an entry collectively identifying the plurality of e-mail versions; receiving a command selecting the entry which collectively identifies the plurality of e-mail versions; and displaying an e-mail of the plurality corresponding to the most recent version.

A second embodiment of the invention comprises a method performed by an e-mail application, the method comprising: receiving commands creating an original collaborative e-mail, wherein the original collaborative e-mail will be edited by collaborating parties, creating new versions of the original collaborative e-mail; assigning a version number to the original collaborative e-mail; receiving a command from a first one of the collaborating parties to send the original collaborative e-mail to at least a second one of the collaborating parties; and displaying an entry in a sent box of the first one of the collaborating parties corresponding to the original collaborative e-mail, wherein the entry identifies the original collaborative e-mail as the original version of the e-mail.

A third embodiment of the invention comprises a computer system, the computer system comprising: at least one memory to store an e-mail application program comprised of machine-readable instructions, where the e-mail application program performs operations to display an interactive graphical user interface when executed; a display for displaying the graphical user interface; and at least one processor coupled to the at least one memory and display, wherein the at least one processor performs at least the following operations when the e-mail application program is executed: receiving a plurality of e-mails, wherein each e-mail of the plurality corresponds to a particular version, wherein the versions range from least recent to most recent; displaying the graphical user interface; in the graphical user interface displaying an entry collectively identifying the plurality of e-mail versions; receiving a command selecting the entry which collectively identifies the plurality of e-mail versions; and displaying an e-mail of the plurality corresponding to the most recent version.

In conclusion, the foregoing summary of the embodiments of the present invention is exemplary and non-limiting. For example, one skilled in the art will understand that one or more aspects or steps from one embodiment can be combined with one or more aspects or steps from another embodiment to create a new embodiment within the scope of the present invention.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 depicts a graphical user interface of an e-mail application operating in accordance with the prior art;

FIG. 2 depicts a network environment in which the methods and apparatus of the invention may be practiced;

FIG. 3 depicts a graphical user interface of an e-mail application operating in accordance with the invention;

FIG. 4 depicts a graphical user interface of an e-mail application operating in accordance with the invention;

FIG. 5 depicts a graphical user interface of an e-mail application operating in accordance with the invention;

FIG. 6 depicts a graphical user interface of an e-mail application operating in accordance with the invention;

FIG. 7 is a flow chart depicting steps of a method operating in accordance with the invention; and

FIG. 8 is a flowchart depicting steps of a method operating in accordance with the invention.

### DETAILED DESCRIPTION OF THE PREFERRED EMBODIMENTS

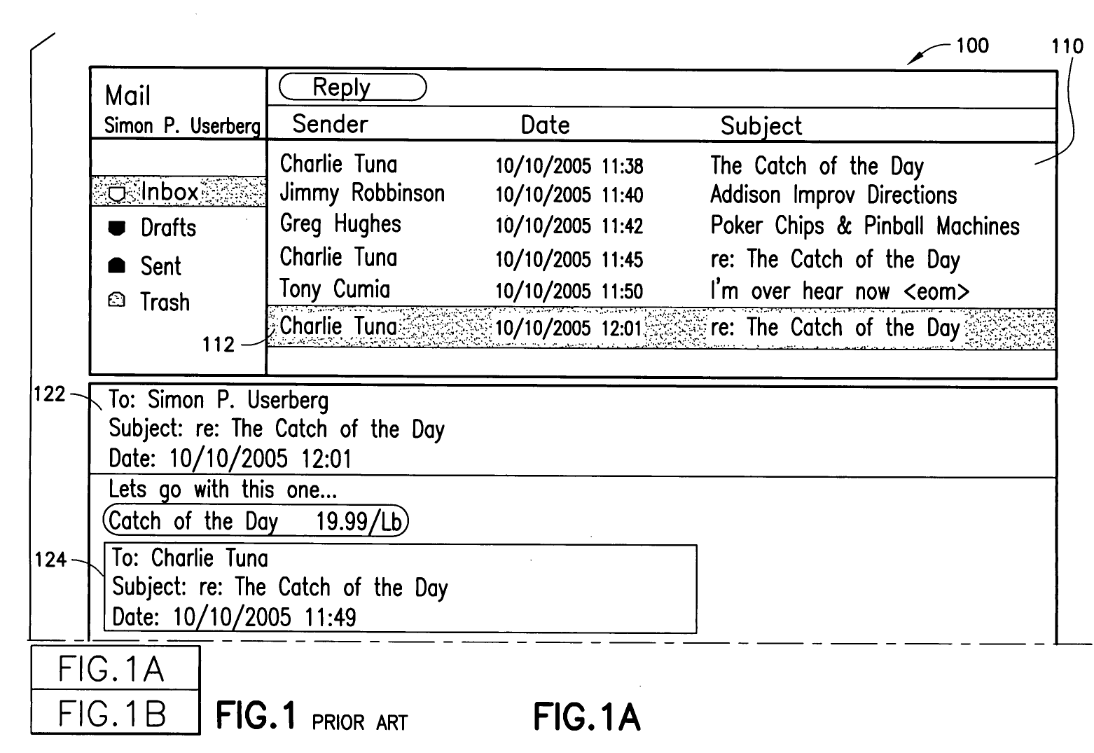

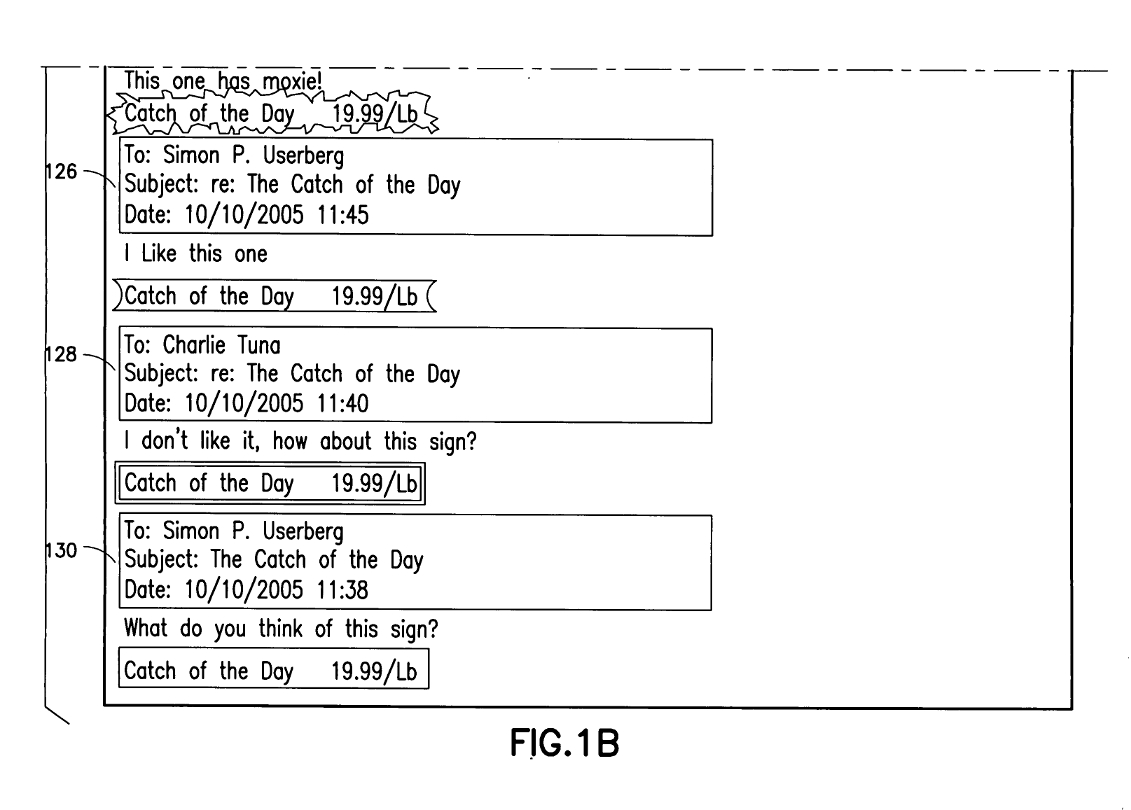

FIG. 1 depicts a graphical user interface 100 of a conventional e-mail application operating in accordance with the prior art. In the graphical user interface 100, the inbox option has been selected and e-mails that have been received by a user are displayed in the inbox region 110 of the graphical user interface 100. A user has selected e-mail entry 112 and the associated e-mail 120 is displayed. E-mail 120 is typical of conventional e-mail applications, and has been created through a series of reply operations following the sending of an original e-mail 130, reflected at the bottom of e-mail 120. As is apparent, the e-mail correspondents were involved in content creation, and engaged in an exchange trying to decide the best solution. The exchange resulted in a final e-mail needlessly cluttered with multiple address segments and superseded messages, as shown by components 124, 126, 128 and 130. Only message component 122 of e-mail 120 is of interest to the participants, since the other components have been superseded. In instances where an e-mail created by multiple reply and forward steps is comprised mainly of formatted text, it may even be more difficult to decipher where an old message ends and a new message begins.

This illustrates the limitations of the prior art. In instances where e-mails are used in a collaboration between two participants, and where the collaboration spans many e-mails, the participants at the end of the collaboration end up with e-mails cluttered with superseded information. As this superseded information is sent back and forth each time a new e-mail reply is generated network bandwidth and storage space is needlessly consumed. In addition, if the participants are maintaining a hard copy correspondence file of the e-mails, the correspondence file will be difficult to construct since each e-mail in the sequence contains all the prior e-mails received in the sequence. This will result in a needlessly bulky correspondence file which is difficult to use.

The present invention overcomes these limitations of the prior art. In particular, the invention organizes e-mails as “versions”, and collectively identifies the e-mail versions by a single entry in, for example, an e-mail inbox. Although multiple e-mail “versions” are initially collectively identified by a single entry, the “versions” in a collection can be rapidly displayed by toggling a control. After toggling the control, entries are displayed identifying each e-mail version, and when the user accesses a particular e-mail version through the entry associated with the particular e-mail, the user is only presented with the contents of that particular e-mail. The user will not be presented with content associated with prior e-mails in the sequence.

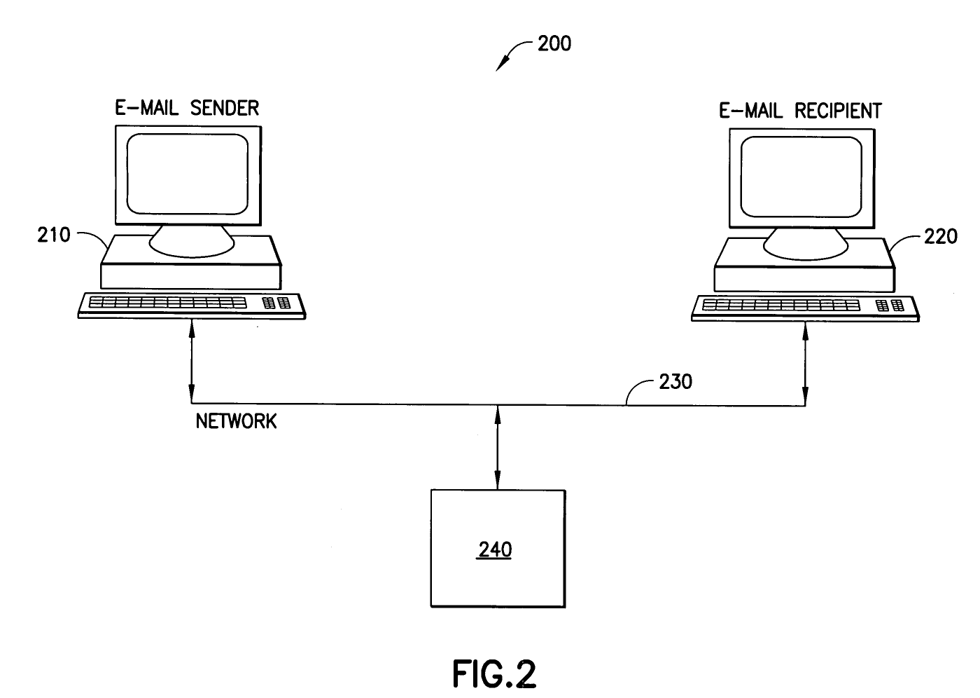

The methods and apparatus of the present invention may be practiced in a network environment 200 like that depicted in FIG. 2. In a typical implementation, e-mails having the features of the present invention are drafted at e-mail sender's computer 210 and sent across a network 230 to a server 240 that administers an e-mail system operating in accordance with the present invention. When e-mail recipient accesses her e-mail application on her computer 220, e-mails that have been sent to her are retrieved and displayed on a display device of computer 220. Other implementations are possible within the context of the invention, where the functionality of the invention is distributed among the components depicted in FIG. 2 in a different manner.

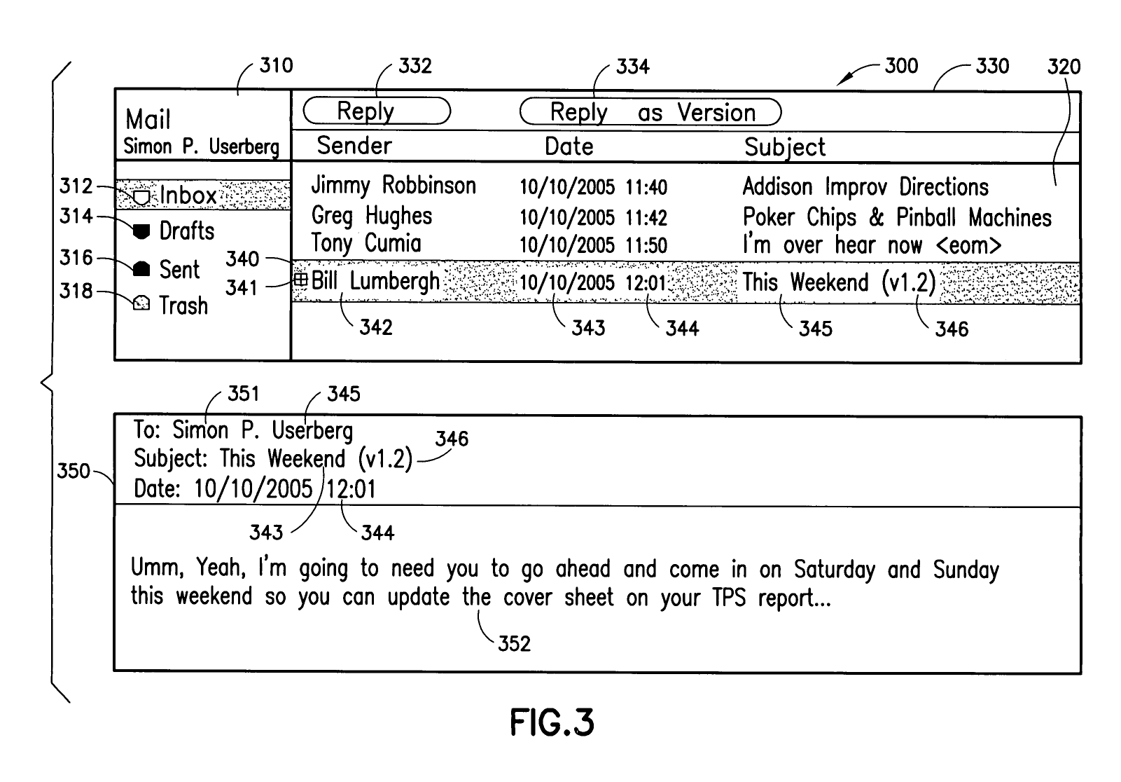

FIG. 3 depicts a graphical user interface 300 operating in accordance with the invention. The graphical user interface 300 comprises an e-mail organization region 310 for organizing e-mails according to whether the e-mails were received by the user; are in the process of being drafted by the user; have been sent by the user; or have been discarded by the user. E-mails received by the user are available through the inbox option 312. E-mails in the process of being drafted by a user are available through the draft option 314. E-mails that have been sent by a user are available through the sent option 316. E-mails are discarded through trash option 318.

As is apparent, the inbox option 312 is currently selected and the e-mails that have been received by the user are visible in the inbox region 320 of the graphical user interface 300. There are four entries in the inbox region 320 corresponding to e-mails that have been received by the user. Three of the e-mails entries are conventional, and are identified by the sender; date and time received; and by a subject line. The fourth e-mail entry 340 corresponds to a collection of e-mail versions and is an aspect of the invention. In contrast to the conventional e-mail entries, the fourth e-mail entry 340 has an additional +/− control (hereinafter referred to as a “twisty control”) for surfacing and submerging previous e-mail versions comprising the collection of e-mails represented by entry 340. In addition to conventional sender information 342; date and time received information 343, 344; and subject information 345, e-mail entry 140 further comprises a version indicator 346 indicating the version number of the most recent e-mail of the collection received. The sender information 342; date and time received information 343, 344; and subject information 345 are associated with e-mail version 1.2, which is the most recent e-mail of the collection received.

By selecting the e-mail entry 340 in any portion of the highlighted region, the most recent e-mail version will be displayed. This is shown by e-mail 350. In addition to the date and time received information 343, 344; subject information 345; and version information 346, e-mail 350 also has addressee information 351 and contents 350. This illustrates a particular advantage of the invention. Although e-mail entry 340 corresponds to a collection of e-mails (typically having to do with a common subject), the user will not be presented with all of the e-mails of the collection when the user enters a command selecting entry 340. Instead, only the most recent e-mail is shown. This avoids the confusion associated with e-mails created in accordance with conventional practice through multiple reply or forward operations which typically contain both new message information and old message information associated with previous e-mails. In embodiments of the invention, the user can immediately access only the most recent information contained in the most recent e-mail. The user will not be presented with old and already superseded information associated with previous e-mails.

In addition, if the is user making hard copies of the e-mail for record-keeping purposes, the user will not be presented with an e-mail that may be many pages long due to incorporation of old information associated with previous e-mails in a sequence.

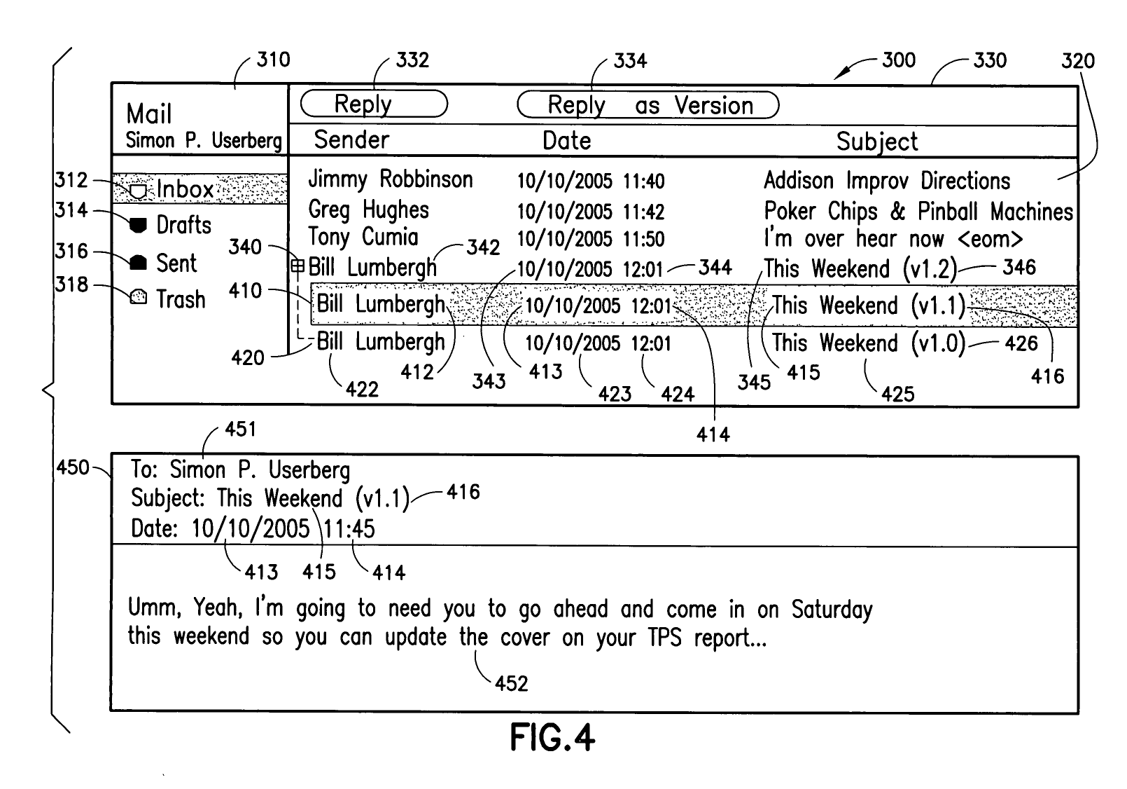

The other e-mails of the collection nonetheless are also immediately accessible in embodiments of the invention. The user can access them using the twisty control 341, which causes them to surface as separate entries 410, 420 in the inbox region 320 of the e-mail graphical user interface as shown in FIG. 4. In addition to original e-mail entry 340, new e-mail entries 410, 420 are now shown in the inbox region 320 of the e-mail graphical user interface 320. E-mail entries 410, 420 provide sender information 412, 422; date 413, 423 and time 414, 424 received information; subject information 415, 425; and version information 416, 426. Upon display, the prior e-mail versions are immediately accessible like the most recent e-mail 340 was in FIG. 3. All a user need do is to select e-mails 410, 420 in conventional manner by, e.g., clicking on the entry when it is highlighted, and the previous e-mail version will become visible. E-mail version 1.1 (450) has been selected in the example depicted in FIG. 4 and is visible. The e-mail 450 comprises addressee information 451; subject information 415; date and time received information 413, 414, in addition to version information 416.

The example depicted in FIG. 4 again illustrates the previously-described advantage of the present invention. When a user accesses a particular e-mail version in a sequence, only that e-mail is displayed. The clutter associated with e-mails created by a send-reply-forward paradigm in accordance with the prior art is avoided.

Another advantage of the invention is apparent from the simultaneous display of the e-mail version sequence in the inbox region 320 and a particular e-mail version. Up/down arrow controls or similar controls can be used to scroll through the e-mail versions. The display of time and date information associated with the various e-mail versions in close proximity to one another in the inbox region 320 while simultaneously displaying the individual e-mail versions, allows a user to more easily develop an understanding of not only the information reflected in the e-mail versions themselves, but also a detailed understanding of when the e-mails were received from a chronological perspective. The conventional e-mail depicted in FIG. 1 is atypical in that each message is short, and is comprised of mainly graphical information. The typical situation is that each e-mail is comprised of text with the result that, if the e-mails in the sequence are lengthy, it is difficult to tell where one begins, and another leaves off. Further, when the headings are spread out among many pages of text, it is difficult not only to find them, but also to develop an understanding of the chronological information reflected in them, since this information is not displayed in close proximity.

The methods of identifying, organizing and displaying e-mails reflected in FIGS. 3 and 4 operated in an inbox of an e-mail recipient like one operating computer 220 in FIG. 2, and concerned e-mails received from a single sender. This is accomplished by the e-mail sender in the network environment depicted in FIG. 2 creating the e-mails as versions using a version control like 334 depicted in FIGS. 3 and 4. Information identifying an e-mail as a “version” and assigning an e-mail a particular version number is generated whenever a new e-mail version is created. The methods of identifying, organizing and displaying e-mails created as versions would be equally applicable to an e-mail sender's “sent” box.

When examined from the perspective of a sender, the invention provides the sender with unique advantages. In instances where an initial e-mail may not have been carefully considered or drafted prior to sending out, the version method of the present invention would hide this potentially embarrassing information from view upon creation of a new e-mail version. The preceding poorly-considered or -drafted message is not automatically tacked onto the end of the new message as in the case of conventional “forwarding” operation of an e-mail constructed in accordance with the prior art. In a conventional e-mail system a user who wished to, for example, refine an instruction, would use the “forward” command to send new information associated with the original e-mail. A disadvantage of this is that the preceding e-mail is automatically appended at the bottom of the new e-mail meaning it continues to be displayed in the new e-mail. The method of the invention avoids this by displaying e-mails in a sequence one-at-a-time. Thus, an e-mail recipient receiving a new e-mail would not be presented with the prior poorly-drafted or poorly-thought-through previous e-mail.

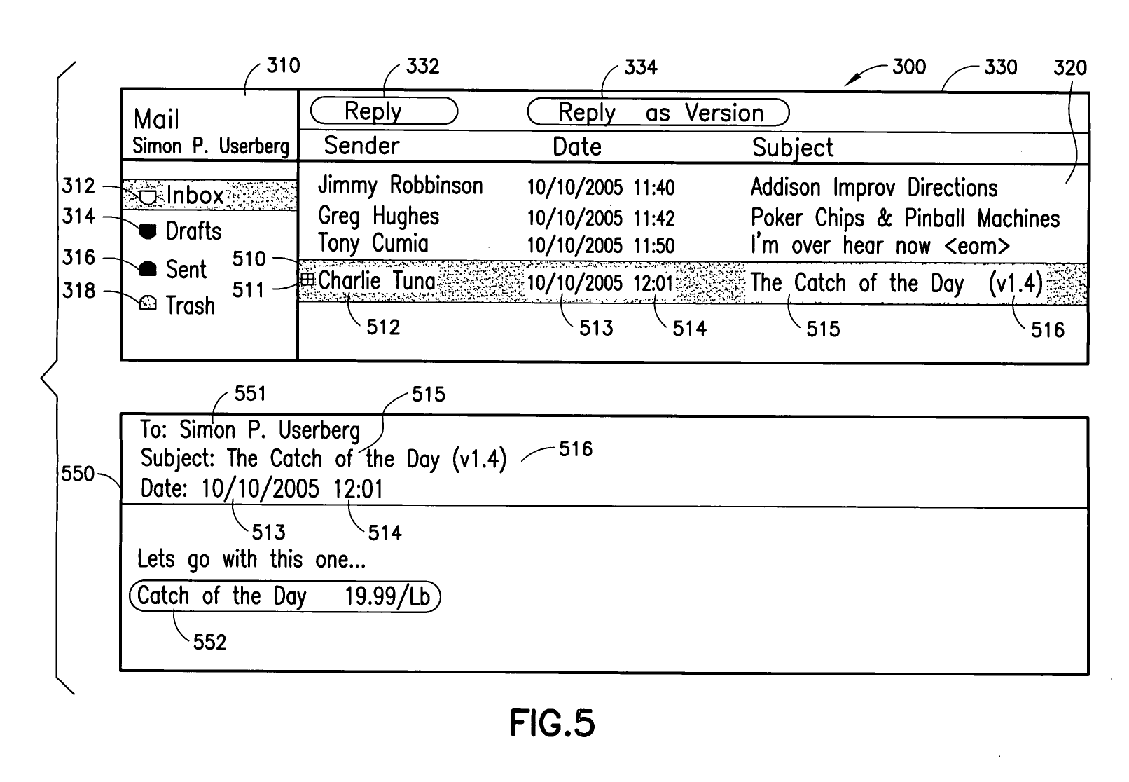

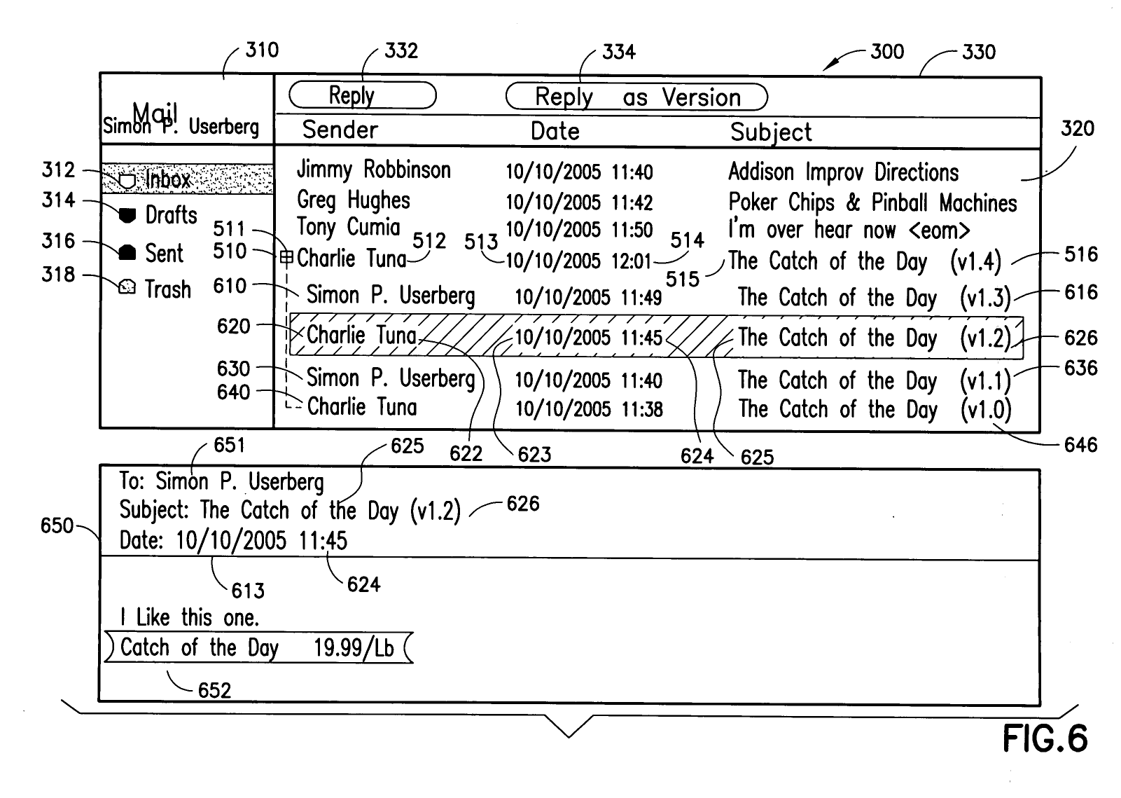

The methods of the invention reflected in FIGS. 3 and 4 when e-mail versions are generated by single user are equally applicable when e-mails are generated by multiple users, and are particularly useful when users are collaborating on a project or group activity. A graphical user interface operating in accordance with this aspect of the invention is depicted in FIGS. 5-6. The e-mail graphical user interface 300 is organized in similar manner to that depicted in FIGS. 3-4. As in the case of FIGS. 3-4, a user has selected the inbox option with control 312, causing the e-mails that have been received by the user to be displayed. As is apparent, one e-mail received by the user has been created using the methods of the present invention. Entry 510 identifies the e-mail created in accordance with the present invention, and comprises subject information 512; date and time received information 513, 514; subject information 515; and version information 516. Version information reflects the fact that five e-mail versions have been created in total. The user has entered a command (such as, for example, clicking on the entry once it has been highlighted, although other command combinations known to those skilled in the art can be used to select an entry) causing the most recent e-mail version to be displayed. E-mail 550 comprises addressee information 551; subject information 515; date and time received information 513, 514; content information 552; and version information 516.

Also apparent in entry 510 is twisty control 511. Toggling twisty control 511 causes prior e-mail versions to be displayed as shown in FIG. 6. Entries 610, 620, 630 and 640 corresponding to prior e-mail versions 1.3; 1.2; 1.1; and 1.0 are then displayed. The user has highlighted and clicked on entry 620 causing e-mail 650 corresponding to version 1.2 to be displayed. E-mail entry 620 comprises sender information 622; date and time received information 623, 624; subject information 625; and version information 626. E-mail 650 comprises addressee information 651; subject information 625; date and time received information 623, 624; and version information 626.

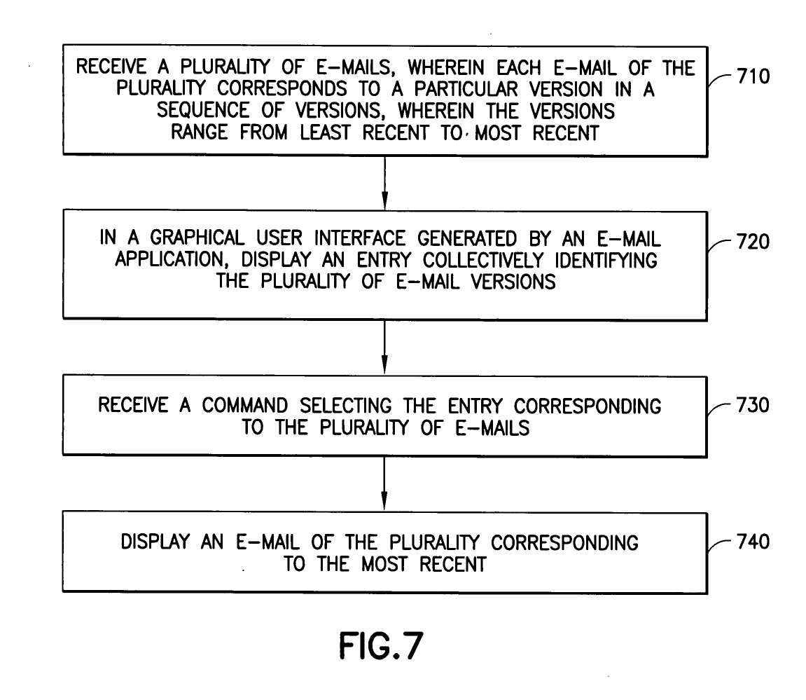

FIG. 7 is a flowchart depicting a method operating in accordance with the present invention, which will be described with reference to the previous figures. At step 710, a plurality of e-mails is received, wherein each of the plurality corresponds to a particular version in a sequence of versions, wherein the versions range from least recent to most recent. “Received” encompasses many situations, and refers to actions of a computer performing methods in accordance with the invention. For example, it refers to a user who creates a sequence of versions of an original e-mail over a period of time where each version is sent after creation to a recipient. The created e-mails are “received” both by the computer of the sending party as a result of the creation process, and by the computer of the addressee referred to in the sent e-mails. It also encompasses situations where collaborators exchange a sequence of updated versions of an original collaborative e-mail as shown in FIGS. 5-6. The computers of each of the collaborators “receive” the emails. Next, at step 720, an entry is displayed in a graphical user interface generated by an e-mail application collectively identifying the plurality of e-mails. This step is illustrated by entry 340 in FIG. 3 and by entry 510 in FIG. 5. As discussed previously, entries 340 and 510 collectively identify a set of e-mails that are related in some one way. For example, entries 410,420 depicted in FIG. 4 identify and correspond to prior versions of the e-mail identified by entry 340 in FIG. 3, and concern a particular topic of interest to the two persons corresponding. Alternatively, entry 510 in FIG. 5 collectively identifies a set of e-mails that were created by a back-and-forth exchange between parties in a collaborative activity. Next, at step 730 a command is received selecting the entry collectively referring to the plurality of e-mails. This can be accomplished by any number of control actions known to those skilled in the art. For example, the region of the graphical user interface in the vicinity of the entry can be clicked on, causing the entry to become highlighted. Then, once highlighted, the entry can be double-clicked on, causing the e-mail to be displayed at step 740.

In one variant of the method of the invention depicted in FIG. 7 additional steps are performed. For example, in a first additional step a command entered with a control like 341 or 511 depicted in FIGS. 3 and 5, respectively, would be received, requesting that entries identifying, and corresponding to, each of the versions be displayed. Then, in a next step, the entries corresponding to each of the versions of the plurality would be displayed. Once displayed, each of the prior e-mail versions is available for selection and display by selecting the entry corresponding to any particular one of the prior e-mail versions.

In a preferred embodiment, while one of the less recent e-mails is being displayed, the entries corresponding to, and identifying the various e-mail versions corresponding to the plurality continue to be displayed. Continuing to display the entries identifying the e-mails while displaying a particular e-mail version helps a user to develop more easily an understanding of not only the substance of the e-mails, but also an understanding of the chronological information reflected in the time and date the e-mail versions were sent or received. In another related variant of the method depicted in FIG. 7, the additional steps of receiving a series of commands to successively display individual ones of the plurality of e-mails; and successively displaying one of the plurality of e-mails after each command, while continuing to display the entries identifying each of the e-mails, are performed.

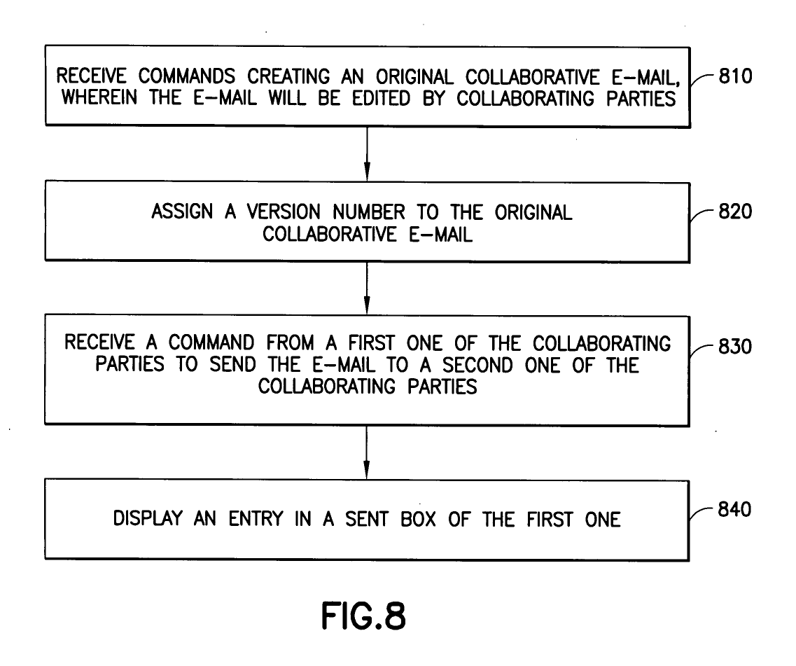

FIG. 8 depicts another method of the invention. At step 810, a computer programmed to perform methods in accordance with the invention receives commands from a first one of a plurality of collaborating parties to create an original collaborative e-mail, wherein the original e-mail will be edited by the collaborating parties. Then, at step 820, a version number is assigned to the original e-mail. Next, at step 830, the computer receives a command from the first one of the collaborating parties to send the e-mail to a second one of the collaborating parties. Next, at step 840, an entry corresponding to the original collaborative e-mail is displayed in a sent box of the first one of the collaborating parties.

A variant of the embodiment depicted in FIG. 8 is especially advantageous for collaborating parties. In a first additional step, a new version of the original collaborative e-mail is received from the second one of the collaborating parties at the computer of the first collaborating party. Then, in a second additional step, an entry is displayed in an inbox of a graphical user interface by the computer of the first collaborating party, wherein the entry collectively identifies both the updated version and the original collaborative e-mail by referring to the updated version, and by indicating that the updated version is later version of the earlier original collaborative e-mail. Handling e-mails as “versions” assists collaborating parties because the parties need not look through a collection of e-mails seeking to develop an understanding of the collaboration. Instead, all the information associated with the collaboration is organized in a set of e-mail versions that are collectively identified and accessed. In addition, as new versions are received, a version number indicated in, for example, a subject line, is updated, and the entry collectively identifying the set of e-mails is returned to the top of the inbox to indicate its status as the most-recently-received e-mail.

In further steps, a computer of the first collaborating party receives a command selecting the entry which collectively identifies both the new version and the original collaborative e-mail; and the computer displays the new version of the original collaborative e-mail. In still further steps, the computer receives a command to display an entry corresponding to the original collaborative e-mail; and the computer displays the entry corresponding to the original collaborative e-mail immediately adjacent to the entry corresponding to the new version.

In another variant of the method depicted in FIG. 8 additional steps are performed. In a first additional step, a plurality of new versions of the original collaborative e-mail is received at a computer of at least one of the collaborating parties. In another step, the computer of the at least one of the collaborating parties updates an entry in a graphical user interface displayed in a display device of the computer after receipt of each new version of the original collaborative e-mail, wherein the updated entry collectively identifies the plurality of e-mails received so far, and wherein the updated entry further identifies the most recent e-mail of the plurality received so far. In a further step, after receipt of at least one of the new versions of the original collaborative e-mail, the computer receives a command selecting the entry collectively identifying the plurality of e-mail versions received so far, and displays the most recent version of the original collaborative e-mail.

In a further variant of the method depicted in FIG. 8 the computer of the at least one of the collaborating parties receives a command to display entries for each of the plurality of e-mail versions from the least recent to the most recent; and the computer displays in a graphical user interface entries for each of the plurality of e-mail versions, wherein the entries are displayed as a group in the graphical user interface.

In yet another variant of the method depicted in FIG. 8, the computer of the at least one of the collaborating parties receives a command selecting an entry corresponding to a particular e-mail version other than the most recent e-mail version; and displays the particular e-mail version, wherein while displaying the particular e-mail version, the entries associated with each of the e-mail versions received so far remain visible.

One of ordinary skill in the art will understand that the methods depicted and described herein can be embodied in a tangible machine-readable memory medium. A computer program fixed in a machine-readable memory medium and embodying a method or methods of the present invention perform steps of the method or methods when executed by a digital processing apparatus coupled to the machine-readable memory medium. Tangible machine-readable memory media include, but are not limited to, hard drives, CD- or DVD-ROM, flash memory storage devices or in a RAM memory of a computer system. A machine-readable memory medium tangibly embodying such a computer program comprises an embodiment of the present invention. A computer programmed to perform methods of the present invention comprising a memory and digital processing apparatus coupled to the memory also comprises an embodiment of the invention.

Thus it is seen that the foregoing description has provided by way of exemplary and non-limiting examples a full and informative description of the best methods and apparatus presently contemplated by the inventors for implementing versioned e-mail creation and display. One skilled in the art will appreciate that the various embodiments described herein can be practiced individually; in combination with one or more other embodiments described herein; or in combination with e-mail application programs differing from those described herein. Further, one skilled in the art will appreciate that the present invention can be practiced by other than the described embodiments; that these described embodiments are presented for the purposes of illustration and not of limitation; and that the present invention is therefore limited only by the claims which follow.

We claim:

1. A signal-bearing medium tangibly embodying a program of machine-readable instructions executable by a digital processing apparatus of a computer system to perform operations for managing an e-mail application, the operations comprising:
receiving a plurality of e-mails, wherein each e-mail of the plurality corresponds to a particular version, wherein the versions range from least recent to most recent;
in a graphical user interface generated by the e-mail application, displaying an entry collectively identifying the plurality of e-mail versions;
receiving a command selecting the entry which collectively identifies the plurality of e-mail versions; and
displaying an e-mail of the plurality corresponding to the most recent version.

2. The signal-bearing medium of claim 1 wherein the operations further comprise:
receiving a command to display entries for each of the plurality of e-mail versions from the least recent to the most recent; and
displaying entries for each of the plurality of e-mail versions, wherein the entries are displayed as a group in the graphical user interface.

3. The signal-bearing medium of claim 2 wherein each entry identifies the particular e-mail version corresponding to the entry by a version number.

4. The signal-bearing medium of claim 2 wherein the operations further comprise:
receiving a command selecting an entry corresponding to a particular e-mail version other than the most recent e-mail version; and
displaying the particular e-mail version.

5. The signal-bearing medium of claim 4 wherein while displaying the particular e-mail, the entries associated with each of the plurality of e-mail versions continue to be displayed.

6. The signal-bearing medium of claim 2 wherein the operations further comprise:
receiving a series of commands to successively display individual ones of the plurality of e-mail versions; and
successively displaying individual ones of the plurality of e-mail versions after each command, while continuing to display the entries identifying each of the e-mail versions of the plurality.

7. The signal-bearing medium of claim 1 wherein the entry collectively identifying the plurality of e-mails is displayed in an inbox of the graphical user interface.

8. The signal-bearing medium of claim 1 wherein the entry collectively identifying the plurality of e-mails is displayed in a sent box of the graphical user interface.

9. The signal-bearing medium of claim 1 wherein each succeeding e-mail version of the plurality comprises new information not reflected in an immediately preceding e-mail version.

10. A method performed by an e-mail application, the method comprising:
receiving commands creating an original collaborative e-mail, wherein the original collaborative e-mail will be edited by collaborating parties, creating new versions of the original collaborative e-mail;
assigning a version number to the original collaborative e-mail;
receiving a command from a first one of the collaborating parties to send the original collaborative e-mail to at least a second one of the collaborating parties; and
displaying an entry in a sent box of the first one of the collaborating parties corresponding to the original collaborative e-mail, wherein the entry identifies the original collaborative e-mail as the original version of the e-mail.

11. The method of claim 10 further comprising:
receiving a new version of the original collaborative e-mail from the second one of the collaborating parties at a computer of the first collaborating party; and
displaying an entry in an inbox displayed in a graphical user interface by the computer of the first collaborating party, wherein the entry collectively identifies both the new version and the original collaborative e-mail, by referring to the new version and indicating that the new version is a later version of an earlier original collaborative e-mail.

12. The method of claim 11 wherein the new version of the original collaborative e-mail comprises only new information.

13. The method of claim 11 further comprising:
receiving a command selecting the entry which collectively identifies both the new version and the original collaborative e-mail; and
displaying the new version of the original collaborative e-mail.

14. The method of claim 11 further comprising:
receiving a command to display an entry corresponding to the original collaborative e-mail; and
displaying the entry corresponding to the original collaborative e-mail immediately adjacent to the entry corresponding to the new version.

15. The method of claim 14 further comprising:
receiving a command selecting the entry corresponding to the original collaborative e-mail; and
displaying the original collaborative e-mail.

16. The method of claim 15 wherein when the original collaborative e-mail is displayed, the entries corresponding to the new version and original collaborative version remain visible.

17. The method of claim 10 further comprising:
at a computer of at least one of the collaborating parties, successively receiving a plurality of new versions of the original collaborative e-mail;
after receipt of each new version of the original collaborative e-mail, updating an entry in a graphical user interface displayed on a display device of the computer of the at least one of the collaborating parties, wherein the updated entry collectively identifies the plurality of e-mails received so far, and wherein the updated entry further identifies the most recent e-mail of the plurality received so far;
after receipt of at least one of the new versions of the original collaborative e-mail, receiving a command selecting the entry collectively identifying the plurality of e-mail versions received so far; and
displaying the most recent version of the original collaborative e-mail.

18. The method of claim 17 further comprising:
receiving a command to display entries for each of the plurality of e-mail versions from the least recent to the most recent; and
displaying entries for each of the plurality of e-mail versions, wherein the entries are displayed as a group in the graphical user interface.

19. The method of claim 18 further comprising:
receiving a command selecting an entry corresponding to a particular e-mail version other than the most recent e-mail version; and
displaying the particular e-mail version, wherein while displaying the particular e-mail version, the entries associated with each of the e-mail versions received so far remain visible.

20. A computer system comprising:
at least one memory to store an e-mail application program comprised of machine-readable instructions, where the e-mail application program performs operations to display an interactive graphical user interface when executed;
a display for displaying the graphical user interface; and
at least one processor coupled to the at least one memory and display, wherein the at least one processor performs at least the following operations when the e-mail application program is executed:
receiving a plurality of e-mails, wherein each e-mail of the plurality corresponds to a particular version, wherein the versions range from least recent to most recent;
displaying the graphical user interface;
in the graphical user interface displaying an entry collectively identifying the plurality of e-mail versions;
receiving a command selecting the entry which collectively identifies the plurality of e-mail versions; and
displaying an e-mail of the plurality corresponding to the most recent version.
